(19) United States
(12) Patent Application Publication
(10) Pub. No.: US 2015/0180180 A1
(43) Pub. Date: Jun. 25, 2015

(54) CHARGE CABLE

(71) Applicant: MS Techvision Co., Ltd., Ansan-Si (KR)

(72) Inventor: Duk Hee KIM, Gunpo-Si (KR)

(21) Appl. No.: 14/578,314

(22) Filed: Dec. 19, 2014

(30) Foreign Application Priority Data
Dec. 20, 2013 (KR) 10-2013-0160319

(51) Int. Cl. H01R 13/713

(52) U.S. Cl. CPC H01R 13/7137

(57) ABSTRACT

The present invention provides a charge cable. The charge cable includes a first connector connected to an electronic device, a second connector connected to a power supply unit, a connection cable connecting the first connector to the second connector, and an overheating prevention member disposed in the first connector to detect a temperature of the first connector, thereby controlling supply of power.

### CROSS-REFERENCE TO RELATED APPLICATION

This application claims priority to Korean Patent Application No. 10-2013-0160319 filed on Dec. 20, 2013 and all the benefits accruing therefrom under 35 U.S.C. §119, the contents of which are incorporated by reference in their entirety.

### BACKGROUND

The present disclosure relates to a charge cable, especially relates to the charge cable that is capable of preventing fire due to an overheated connector from occurring.

Most of portable electronic devices such as smartphones, digital cameras, and laptop computers includes built-in batteries to receive direct current (DC) power for operating. For this, a charge cable for connecting an electronic device to a power supply unit to charge the electronic device with power supplied from the power supply unit may be used. The charge cable may be constituted by a first connector inserted into the electronic device, a second connector inserted into a USB terminal, and a connection cable connecting the first and second connectors to each other. That is, when the first connector is inserted into the electronic device, and the second connector is inserted into the USB terminal, the electronic device may be charged by the power supplied through the USB terminal.

An example of the charge cable is disclosed in Korean Utility Model Registration No. 20-410889.

However, two thousands of fire accidents per year occur by the charge cable. Most of the fire accidents occurs by the first connector inserted into the electronic device because the first connector is overheated due to short-circuit. The first connector may be overheated by causes such as a case in which foreign substances infiltrate into the first connector, a case in which contact resistance increases due to abrasion and oxidation of the connection terminal between the first connector and the electronic device, a case in which short-circuit occurs due to mis-insertion of the first connector, and a case of intendedness of a black consumer. When the fire occurs in the first connector, the electronic device that is inserted into the first connector may also be damaged.

However, a part or structure for preventing the fire due to the overheating of the first connector has not been provided yet in the existing charge cables.

### SUMMARY

The present disclosure provides a charge cable that is capable of preventing fire due to a first connector from occurring.

The present disclosure also provides a charge cable in which an overheating prevention member is provided in a first connector to prevent fire due to the overheated first connector from occurring.

The present disclosure also provides a reusable charge cable in which an overheating prevention member repeatedly applies and cuts off power depending on a temperature of a first connector.

In accordance with an exemplary embodiment, a charge cable includes: a first connector connected to an electronic device; a second connector connected to a power supply unit; a connection cable connecting the first connector to the second connector; and an overheating prevention member disposed in the first connector to detect a temperature of the first connector, thereby controlling supply of power.

The first connector may further include: an insertion part inserted into the electronic device; and a board or inner case on which a power terminal and a ground terminal are disposed thereon.

The overheating prevention member may be disposed on at least one side of the board or inner case and connected to at least one of the power terminal and the ground terminal.

The overheating prevention member may include a shape memory alloy that is repeatedly contracted and expanded depending on a temperature of the first connector.

The overheating prevention member may includes: a first lead; a spindle connected to the first lead; an elastic member formed of the shape memory alloy to disconnect the first lead from the spindle depending on the temperature of the first connector; and a second lead connected to the spindle.

The first and second leads may be connected to the power terminal or the ground terminal.

The elastic member may be adjusted in expandable temperature by adjusting at least one of a diameter of a wire, the turn number of wire, and a pitch of the wire.

The elastic member may include first and second springs, and the spindle may be disposed between the first spring and the second spring.

The first spring may surround a portion of the spindle to disconnect the spindle from the first lead.

At least one of the first and second springs may be formed of the shape memory alloy.

At least one of the first and second springs may be maintained in the contracted state at a transition temperature or less and is expanded at the transition temperature or more.

The overheating prevention member may be disposed on at least one area on the board or inner case so that the overheating prevention member is connected to at least one of the power terminal and the ground terminal.

The overheating prevention member may include a thermo fuse that is melted and disconnected when the first connector increases to a predetermined temperature.

### BRIEF DESCRIPTION OF THE DRAWINGS

Exemplary embodiments can be understood in more detail from the following description taken in conjunction with the accompanying drawings, in which:

FIG. 1 is a view of a charge cable in accordance with an exemplary embodiment;

FIG. 2 is a plan view of a first connector in accordance with an exemplary embodiment;

FIG. 3 is a perspective view of the first connector in accordance with an exemplary embodiment;

FIG. 4 is a circuit diagram of the first connector in accordance with an exemplary embodiment;

FIG. 5 is a cross-sectional view of an overheating prevention member used in the first connector in accordance with an exemplary embodiment;

FIG. 6 is a flowchart for explaining a charging method using the charge cable in accordance with an exemplary embodiment;

FIGS. 7 and 8 are cross-sectional views for illustrating a method of applying and cutting off power by using the overheating prevention member in accordance with an exemplary embodiment;

FIG. 9 is a graph showing results obtained through a temperature test of the first connector having the overheating prevention member; and

FIG. 10 is a graph showing results obtained through a short-circuit test of the first connector including the overheating prevention member.

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

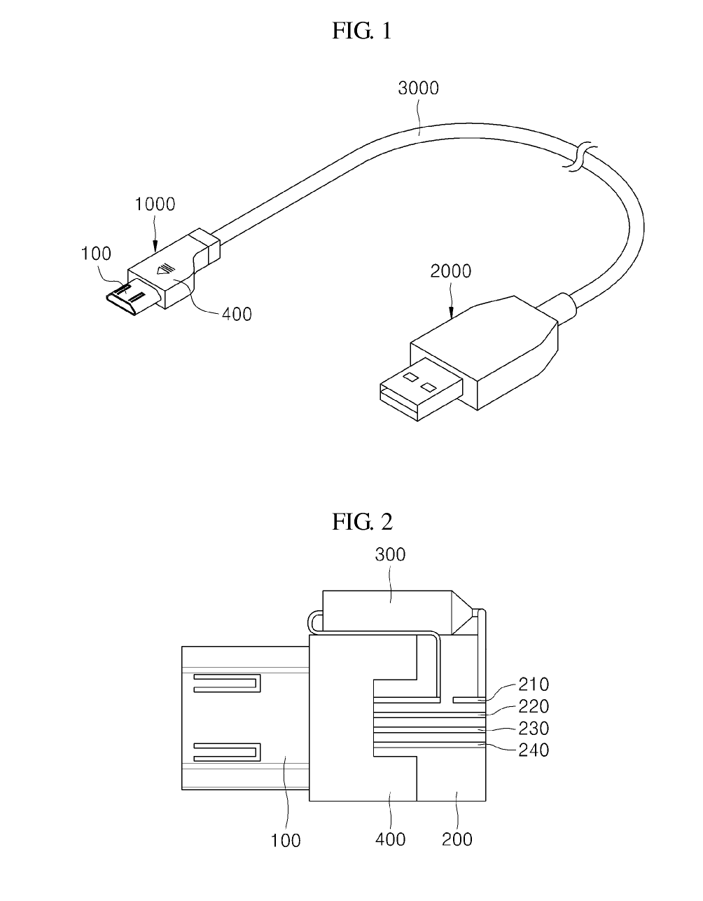

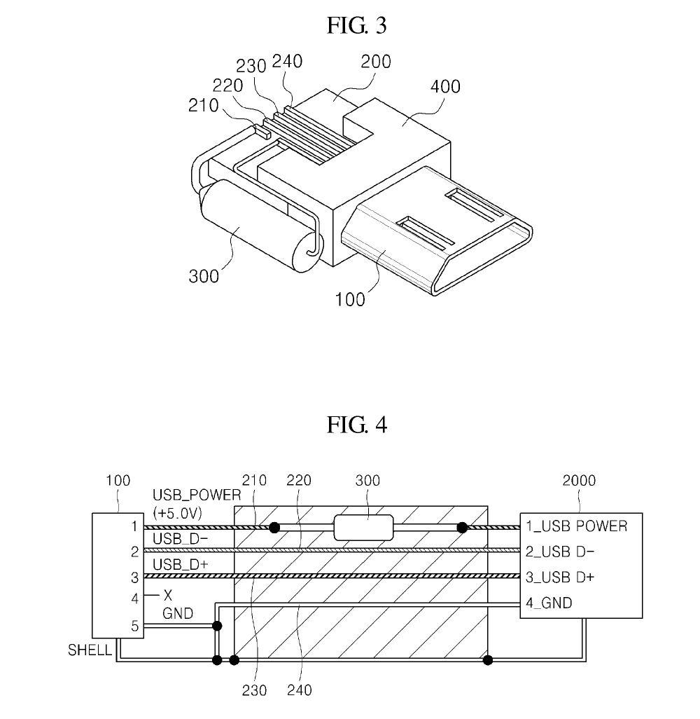

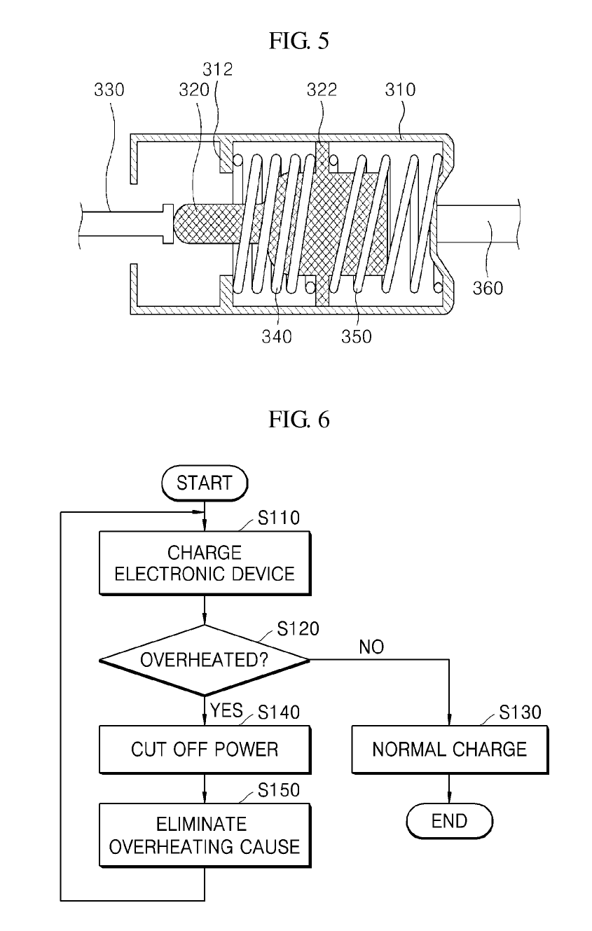

FIG. 1 is a view of a charge cable in accordance with an exemplary embodiment, FIG. 2 is a plan view of a first connector in accordance with an exemplary embodiment, FIG. 3 is a perspective view of the first connector in accordance with an exemplary embodiment, FIG. 4 is a circuit diagram of the first connector in accordance with an exemplary embodiment, and FIG. 5 is a cross-sectional view of an overheating prevention member used in the first connector in accordance with an exemplary embodiment.

As illustrated in FIG. 1, a charge cable in accordance with an exemplary embodiment may include a first connector 1000 inserted into an electronic device, a second connector 2000 inserted into a power supply unit, and a connection cable 3000 connecting the first connector 1000 and the second connector 2000 to each other. The second connector 2000 is inserted into the power supply unit that supplies power, e.g., a USB terminal of a computer. Also, the second connector 2000 may be inserted into an adaptor that converts alternating current (AC) power into direct current (DC) power as well as the USB terminal. That is, the AC power may be converted into the DC power by the adaptor, and the DC power may be supplied into the electronic device through the connection cable 3000 and the first connector 1000 to charge the electronic device.

The first connector 1000 is inserted into the electronic device to supply the power supplied from the power supply unit through the second connector 2000 into the electronic device. As illustrated in FIGS. 2 and 3, the first insertion connector 1000 may further include an insertion part 100 inserted into the electronic device, a board 200 on which a plurality of terminals 210 to 240 are disposed thereon, an overheating prevention member 300 disposed on at least one side of the board 200, and a molding part 400 molding the board 200 and the overheating prevention member 300. For example, a power terminal 210, a negative data terminal 220, a positive data terminal 230, and a ground terminal 240 may be disposed on the board 200. As illustrated in FIG. 4, the power terminal 210 corresponds to a terminal through which the power supplied from the power supply unit is transmitted to the electronic device. Each of the negative and positive data terminals 220 and 230 corresponds to a terminal through which data is transmitted to and received from the computer. Here, the overheating prevention member 300 may be connected to the power terminal 210 as illustrated in FIG. 4. For example, a predetermined area of the power terminal 210 on the board 200 is cut, and each of one terminal and the other of the overheating prevention member 300 may be connected to the cut power terminal 210. The overheating prevention member 300 may be connected to the ground terminal 240. Alternatively, two overheating prevention members 300 may be provided and respectively connected to the power terminal 210 and the ground terminal 240.

When the overheating prevention member 300 is connected to the ground terminal 240, a predetermined area of the ground terminal 240 is cut, and each of one terminal and the other of the overheating prevention member 300 may be connected to the cut ground terminal 240. The overheating prevention member 300 connected to the ground terminal 240 may detect a temperature to float the ground terminal 240 when the detected temperature is greater than a predetermined temperature. Also, an inner case (not shown) may be provided without using the board 200. That is, the inner case may be manufactured through plastic injection, and the plurality of terminals 210 to 240 may be disposed on the inner case. Here, the overheating prevention member 300 may be disposed on the inner case.

The overheating prevention member 300 may apply or cut off the power supplied from the power supply unit depending on a temperature of the first connector 1000. That is, the overheating prevention member 300 may cut off the power supplied from the power supply unit when the first connector 1000 increases in temperature and may apply the power supplied from the power supply unit when the temperature of the first connector 1000 is less than a predetermined temperature. As illustrated in FIG. 5, the overheating prevention member 300 may include a housing 310 in which a predetermined space is defined, a spindle 320 disposed in the housing 310, a first lead 330 and first spring 340 that are disposed on one side of the spindle 320, and a second spring 350 and second lead 360 that are disposed on the other side of the spindle 320.

The housing 310 accommodates the spindle 320 and the first and second springs 340 and 350 therein. Thus, for example, the housing 310 may have a tube shape having an inner space and extending in a longitudinal direction to accommodate all of the above-described parts. Also, an opening is defined on at least one side of the housing 310. The first lead 330 is inserted through the opening. The second lead 360 may be disposed at the other side of the housing 310 facing the opening. The housing 310 may be formed of an insulative material or a conductive material. In the overheating prevention member 300 in accordance with the current embodiment, the second lead 360 is electrically connected to the other side of the housing 310, and thus the housing 310 formed of a conductive material is exemplified. The housing 310 may have a circular, oval or polygonal section in a direction that is perpendicular to the longitudinal direction of the housing 310. In the current embodiment, the housing 310 having a circular section that is perpendicular to the longitudinal direction thereof is exemplified. Also, a hook protrusion 312 may protrude inward from a predetermined position of an inner circumferential surface of the housing 310 in horizontal direction to support a first spring 340. The first spring 340 and a second spring 350 are disposed between the hook protrusion 312 and the other side of the housing (an end on which the second lead 360 is disposed).

The spindle 320 is a unit for connecting the first lead 330 to the second terminal 360 or for disconnecting the first lead 330 from the second terminal 360. The spindle 320 is disposed in the housing 310. The spindle 320 may be provided as a shaft extending in a longitudinal direction like the housing 310 extending in the longitudinal direction. Although the spindle 320 has a circular, oval, or polygonal section that is perpendicular to the longitudinal direction thereof, the section of the spindle 320 may have the same shape as that of the housing 310. That is, as illustrated in FIG. 5, the spindle 320 may have a cylindrical shape like the housing 310 having a circular box shape. The spindle 320 may be electrically connected to the first lead 330 by the first spring 340. Thus, the spindle 320 may be formed of a conductive material. The spindle 320 may be electrically connected or disconnected to the second lead 360 while reciprocating in the housing 310 in the longitudinal direction by expanding and contracting motions of the first and second springs 340 and 350. Thus, the first lead 330 is connected to or spaced apart from the second lead 360 as the spindle 320 is connected to or spaced apart from the second lead 360. A support part 322 for supporting the first spring 340 or the second spring 350 may be disposed on at least one portion of a side surface of the spindle 320 and connected to the first or second spring 340 or 350. The support part 322 may protrude from the side surface of the spindle 320 in a direction perpendicular to an axis direction of the spindle 310. The support part 322 may be continuously disposed along a circumference of the side surface of the spindle 320 or discontinuously disposed on the side surface of the spindle 320. That is, the support part 322 is not limited in shape if the spindle 320 is connected to the first spring 340 or the second spring 350.

The first and second leads 330 and 360 are provided to transmit the power applied from the outside through the second connector 2000. Thus, each of the first and second leads 330 and 360 is formed of a conductive material. Each of the first and second leads 330 and 360 may be connected to the power terminal 210 on the board 200. Here, the first lead 330 may be connected to a connection cable-side power terminal 210, and the second lead 360 may be connected to an insertion part-side power terminal 210. Of course, the first lead 330 may be connected to the insertion part-side power terminal 210, and the second lead 360 may be connected to the connection cable-side power terminal 210. Also, a portion of the first lead 330 is inserted into the housing 310 through the opening and connected to the power supply unit through the second connector 2000. Also, the second lead 360 may be connected at the outside of the other side of the housing 310 and connected to the electronic device through the insertion part 100. The first lead 330 is connected to or spaced apart from the spindle 320 depending on an elastic force of each of the first and second springs 340 and 350. The first connector 1000 may be maintained in a power application state in a state where the first lead 330 is connected to the spindle 320. Also, the first connector 1000 may be maintained in a power cut-off state in a state where the first lead 330 is spaced apart from the spindle 320.

The first spring 340 may be disposed on the spindle 320 toward the first lead 330 to control the connection between the first lead 330 and the spindle 320. Here, the first spring 340 may be disposed between the hook protrusion 312 and the support part 322 and on the circumference at one side of the spindle 320. The first spring 340 may control the connection between the first lead 330 and the spindle 320 depending on a contracted and expanded state thereof. That is, when the first spring 340 is in a contracted state, the first lead 330 is connected to the spindle 320 to maintain the power application state. Also, when the first spring 340 is in an expanded state, the first lead 330 is spaced apart from the spindle 320 to maintain the power cut-off state. Also, the first spring 330 may be maintained in the contracted and expanded state depending on a temperature. Thus, in accordance with the present disclosure, the first spring 340 is formed of a shape memory alloy having a property in which the shape memory alloy is deformed at a transition temperature or less and returns to its original shape at the transition temperature or more. Thus, the first spring 340 may be maintained in a contracted state at the transition temperature or less. When heat is applied to the first spring 340 at the transition temperature or more, the first spring 340 may be expanded. The first spring 340 may be formed of nitinol which is an alloy of titanium (Ti) and nickel (Ni) or an alloy of copper (Cu), zinc (Zn), and aluminum (Al). Also, the first spring 340 may be adjusted in expandable temperature depending on a material thereof, a diameter of the wire, the turn number of wire, and a pitch of the wire. For example, at least one of the material of the first spring 340, the diameter of the wire, the winding number of wire, and the pitch of the wire may be adjusted to allow the first spring 340 to expand at a temperature of approximately 75° C., approximately 95° C., or approximately 115° C.

The second spring 350 is provided to disconnect the first lead 330 from the spindle 320 together with the first spring 340. The second spring 350 may be disposed to surround the other side of the spindle 320. Here, the second spring 350 may be formed of a general metal, but rather than the shape memory alloy, unlike the first spring 350. For example, the second spring 340 may be provided as a silver-plated general metal. That is, the second spring 350 needs a predetermined tensile force, and thus the second spring 350 may be plated with silver having a predetermined thickness so as to assist a flow of current. Thus, a stable current flows through the second spring 350 due to conductivity of the metal itself and the silver plating at a predetermined voltage and current, and then the second spring 350 increases in temperature when overvoltage and overcurrent are applied thereto. Like this, the second spring 350 may be disposed on the other surface of the spindle 320, in a state where the second spring 350 is expanded like as the general spring, to apply a pressure so that the spindle 320 is maintained in a state where the spindle is connected to the first lead 330. When the first spring 340 is expanded, the second spring 350 is contracted to disconnect the first lead 330 from the spindle 320.

In the current embodiment, although the overheating prevention member 330 is manufactured by using the first and second springs 340 and 350 each of which has a coil shape as the elastic member, the present disclosure is not limited thereto. For example, at least one of the first and second springs 340 and 350 may be a spring having a shape except for the coil shape such as a plate shape. Also, the second spring 350 may be formed of the shape memory alloy, and the first spring 340 may be formed of the general spring. Also, all of the first and second springs 340 and 350 may be formed of the shape memory alloy.

As described above, in the overheating prevention member 300 in accordance with an exemplary embodiment, the first and second springs 340 and 350 are disposed with the spindle 320 therebetween in the housing 310. Here, at least one of the first and second springs 340 and 350 may be formed of the shape memory alloy. In accordance with the overheating prevention member 300, when the first connector 1000 is in a predetermined temperature or less, the first spring 340 is in a contracted state so that the first lead 330 is connected to the spindle 320, and when the first connector 1000 is heated at a predetermined temperature or more, the first spring 340 is expanded so that the first lead 330 is spaced apart from the spindle 320.

Thus, when the first connector 1000 is overheated by various causes, the overheating prevention member 300 may detect the causes to cut off the power, thereby preventing fire in the first connector 1000 from occurring.

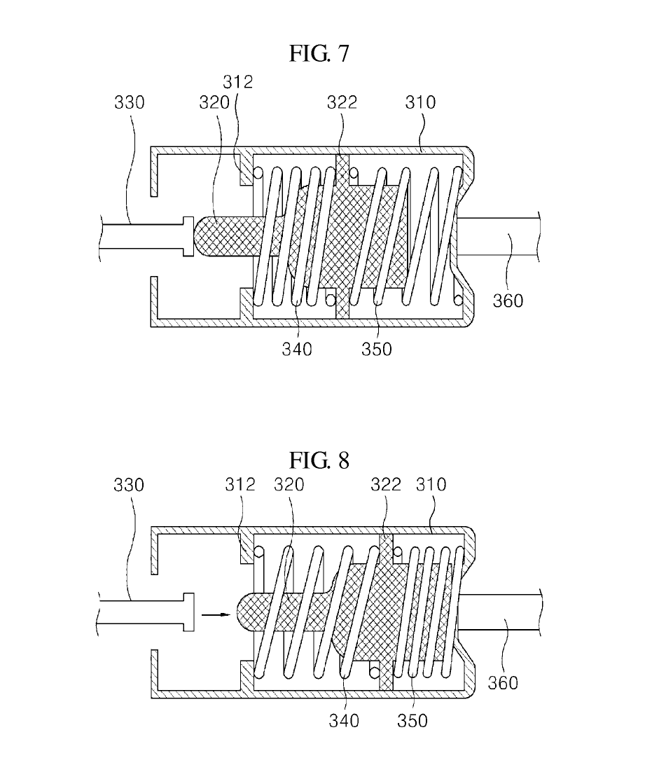

A method of charging using the charge cable including the first connector having the overheating prevention member in accordance with an exemplary embodiment and a method of operating the overheating prevention member will be described below with reference to FIGS. 6 to 8. FIG. 6 is a flowchart for explaining a charging method using the charge cable in accordance with an exemplary embodiment, FIGS. 7 and 8 are cross-sectional views for illustrating a method of applying and cutting off power by using the overheating prevention member in accordance with an exemplary embodiment.

First, in operation S110, the first connector 1000 is connected to the electronic device, e.g., a smartphone, and the second connector 2000 is connected to the power supply unit, e.g., the USB terminal of the computer to charge the electronic device.

Here, since heat is generated in the first connector 1000 during the charging, it is determined whether the generated heat is above a predetermined temperature in operation S120. For example, the first connector 1000 may be overheated by a case in which foreign substances infiltrates into the first connector 1000, a case in which a contact resistance increases due to abrasion and oxidation in the connection terminal between the first connector 1000 and the electronic device, a case in which short-circuit occurs due to mis-insertion of the first connector 1000, and a case of negligence by a black consumer. Here, the overheating prevention member 300 may detect the overheating.

In operation S130, when the first connector 1000 has a temperature at a predetermined temperature or less, the power is continuously supplied from the power supply unit into the electronic device. That is, the first spring 340 of the overheating prevention member 300 is in a contracted state to allow the first lead 330 to be connected to the spindle 320. Here, the second spring 350 may be contracted.

However, in operation S140, when the first connector 1000 has a temperature at a predetermined temperature or more, the power applied from the power supply unit into the electronic device is cut by using the overheating prevention member 300. That is, when the inside of the first connector 1000 is overheated, for example, at approximately 150° C. or more, the overheating prevention member 300 is overheated, for example, at approximately 95° C. or more. Here, as illustrated in FIG. 8, the first spring 340 of the overheating prevention member 300 may be expanded to allow the first lead 330 to be spaced apart from the spindle 320. Here, when the first spring 340 is expanded, the second spring 350 may be contracted. Thus, the power applied from the power supply unit into the electronic device is cut.

When the supply of the power is cut, in operation S150, a user separates the first connector 1000 from the electronic device and eliminates a cause of the overheating to re-connect the first connector 1000 to the electronic device. For example, the foreign substances infiltrated into the first connector 1000 is removed, or the first connector 1000 is properly inserted into the electronic device, so as to eliminate the cause of the overheating.

Then, when the first connector 1000 is cooled, the first spring 340 contacts to re-connect the first lead 330 to the spindle 320, and thus the electronic device is charged. The overheating of the first connector 1000 may be prevented by repeatedly performing the processes, and thus the fire due to the overheating may be prevented.

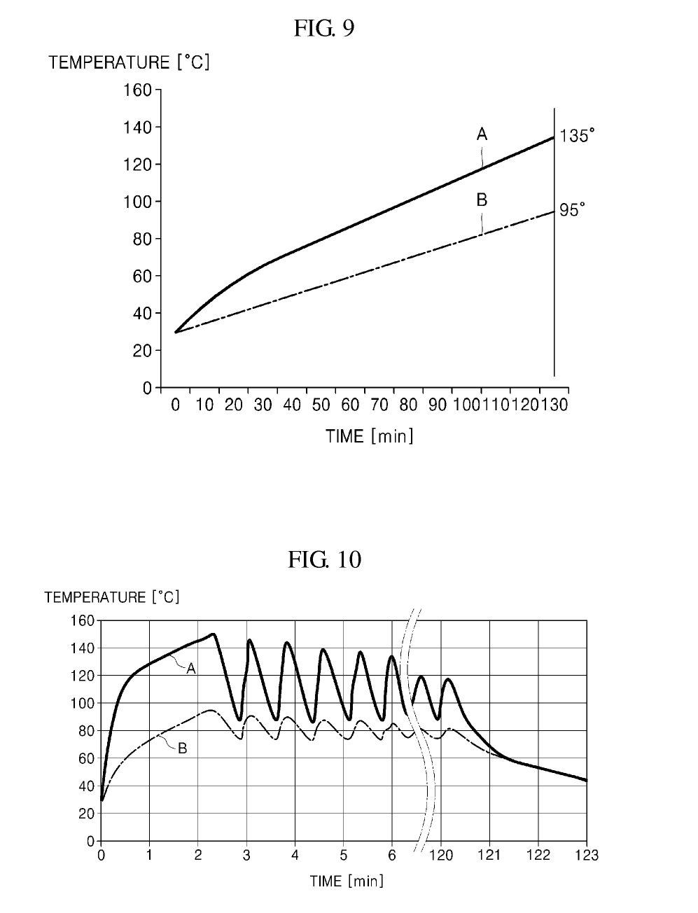

A temperature increase test is performed with respect to the first connector including the overheating prevention member using the above-described shape memory alloy. Results obtained through the test are shown in table 1 and FIG. 9. That is, a thermal wire is disposed at the outside of the terminal of the electronic device under assumption that the heat is generated in the first connector to reproduce a real-life situation. Also, the power is applied into the hot wire while applying a charging voltage and current of approximately 5 V and approximately 2 A so as to increase a temperature of the connection portion between the first connector and electronic device, thereby checking an operation temperature of the overheating prevention member. Here, the temperature is measured by a infrared ray spot thermometer.

TABLE 1

| | First connector | Overheating prevention member operation |
|---|---|---|
| Sample | temperature (° C.) | temperature (° C.) |
| #1 | 135 | 94 |
| #2 | 137 | 96 |
| #3 | 134 | 96 |
| #4 | 134 | 95 |

As shown in Table 1, the first connector is overheated at a temperature of approximately 135° C. to approximately 137° C., and accordingly, the overheating prevention member operates at a temperature of approximately 94° C. to approximately 96° C. to cut off the supply of the power. Also, as illustrated in FIG. 9, the supply of the power is cut approximately 130 min. later due to the above temperature increase.

Also, effect with respect to a rapid temperature increase under assumption that the short-circuit occurs in the first connector is verified, and results obtained through the verification is illustrated in FIG. 10. That is, graphite, i.e., a mechanical pencil lead is inserted between the power terminal of the first connector and a shield of the first connector to reproduce a short-circuit having a resistance of approximately 1Ω to approximately 10Ω. Also, the first connector is connected to a charger. Then, the overheating prevention member operates approximately 150 to approximately 200 times. As illustrated in FIG. 10, when the first connector has a temperature of approximately 150±8° C., the overheating prevention member has a temperature of approximately 95±5° C. Also, when a temperature difference between the first connector and the overheating prevention member is approximately 55 C, the overheating prevention member operates. Also, after the power is cut due to the operation of the overheating prevention member, the power is re-supplied approximately 30 seconds later in which the temperature difference between the first connector and the overheating prevention member is approximately 15° C.

Although the overheating prevention member 300 using the shape memory alloy is described in an exemplary embodiment, various types of overheating prevention members 300 which is controllable the power depending on the temperature of the first connector 100 may be used. For example, a thermo fuse may be used. The thermo fuse may be disposed on at least one area on the board 200. The thermo fuse may be connected to at least one of the power terminal 210 and the ground terminal 240. For example, the thermo fuse may be disposed at a portion of the power terminal 210. Here, a socket may be disposed at a portion of the power terminal 210, and the thermo fuse may be mounted in the socket. The thermo fuse may be cut when the first connector 1000 increases to a predetermined temperature or more to completely cut off the supply of the power. Thus, the thermo fuse may be formed of an alloy of tin (Sn), zinc (Zn), bismuth (Bi), and indium (In). Here, the tin (Sn) may be provided as a main component, and others may be adjusted in content thereof, thereby adjusting a temperature at which the thermo fuse is melted and disconnected. Although the overheating prevention member 300 using the shape memory alloy is repeatedly usable, the overheating prevention member 300 using the thermo fuse is not reusable when the thermo fuse is cut.

In the charge cable in accordance with the exemplary embodiments, the overheating prevention member for detecting the temperature of the first connector connected to the electronic device to supply or cut off the power may be disposed in the first connector. In the overheating prevention member, the first spring and the second spring each of which is formed of the shape memory alloy may be disposed with the spindle therebetween in the housing. Also in the overheating prevention member, when the first connector is maintained at a predetermined temperature or less, the first spring may be maintained in the contracted state to maintain the connection between the first lead and the spindle. Also, when the first connector is heated at a predetermined temperature or more, the first spring may be expanded to allow the first lead to be spaced apart from the spindle.

Thus, when the first connector is overheated by various causes, the overheating prevention member may detect the causes to cut off the supply of the power, thereby preventing the fire in the first connector from occurring. Thus, the charge cable may be improved in reliability and stability. Also, since the first spring of the overheating prevention member is repeatedly contracted and expanded depending on a temperature of the first connector, the overheating prevention member may be unlimitedly repeatedly used. Thus, since it is unnecessary to repair or replace the charge cable, the charge cable may be improved in economic feasibility. Also, the usage of a genuine charge cable may be induced.

Although the charging cable has been described with reference to the specific embodiments, it is not limited thereto. Therefore, it will be readily understood by those skilled in the art that various modifications and changes can be made thereto without departing from the spirit and scope of the present invention defined by the appended claims.

As described above, the technical idea of the present invention has been specifically described with respect to the above embodiments, but it should be noted that the foregoing embodiments are provided only for illustration while not limiting the present invention. Various embodiments may be provided to allow those skilled in the art to understand the scope of the preset invention, but the present invention is not limited thereto.

What is claimed is:

1. A charge cable comprising:
a first connector connected to an electronic device;
a second connector connected to a power supply unit;
a connection cable connecting the first connector to the second connector; and
an overheating prevention member disposed in the first connector to detect a temperature of the first connector, thereby controlling supply of power.

2. The charge cable of claim 1, wherein the first connector further comprises:
an insertion part inserted into the electronic device; and
a board or inner case on which a power terminal and a ground terminal are disposed thereon.

3. The charge cable of claim 2, wherein the overheating prevention member is disposed on at least one side of the board or inner case and connected to at least one of the power terminal and the ground terminal.

4. The charge cable of claim 3, wherein the overheating prevention member comprises a shape memory alloy that is repeatedly contracted and expanded depending on a temperature of the first connector.

5. The charge cable of claim 4, wherein the overheating prevention member comprises:
a first lead;
a spindle connected to the first lead;
an elastic member formed of the shape memory alloy to disconnect the first lead from the spindle depending on the temperature of the first connector; and
a second lead connected to the spindle.

6. The charge cable of claim 5, wherein the first and second leads are connected to the power terminal or the ground terminal.

7. The charge cable of claim 6, wherein the elastic member is adjusted in expandable temperature by adjusting at least one of a diameter of a wire, the turn number of wire, and a pitch of the wire.

8. The charge cable of claim 7, wherein the elastic member comprises first and second springs, and
the spindle is disposed between the first spring and the second spring.

9. The charge cable of claim 8, wherein the first spring surrounds a portion of the spindle to disconnect the spindle from the first lead.

10. The charge cable of claim 9, wherein at least one of the first and second springs is formed of the shape memory alloy.

11. The charge cable of claim 10, wherein at least one of the first and second springs is maintained in the contracted state at a transition temperature or less and is expanded at the transition temperature or more.

12. The charge cable of claim 2, wherein the overheating prevention member is disposed on at least one area on the board or inner case so that the overheating prevention member is connected to at least one of the power terminal and the ground terminal.

13. The charge cable of claim 12, wherein the overheating prevention member comprises a thermo fuse that is melted and disconnected when the first connector increases to a predetermined temperature.
